(19) United States
(12) Patent Application Publication
(10) Pub. No.: US 2016/0100307 A1
(43) Pub. Date: Apr. 7, 2016

(54) Roaming Cellular Transmission System

(71) Applicant: Netanel Avner, Mevaseret (IL)

(72) Inventor: Netanel Avner, Mevaseret (IL)

(21) Appl. No.: 14/054,751

(22) Filed: Oct. 15, 2013

Related U.S. Application Data
(60) Provisional application No. 61/712,835, filed on Oct. 12, 2012.

(51) Int. Cl. H04W 8/06; H04W 88/06; H04B 7/26

(52) U.S. Cl. CPC H04W 8/06; H04B 7/26; H04W 88/06

(57) ABSTRACT

The present invention is a system and method for providing access to a home cellular network when a cellular transmission device is not physically located near said home network having a cellular transmission device having a sim card configured for access to a home cellular network;

an overlay or parallel sim card with operator IMSI wherein said overlay or parallel sim card and said home sim card are constructed and arranged to function contemporaneously with a singular cellular transmission device;

an HLR, wherein said HLR is configured to be operatively associated with an operator local global title;

a VLR wherein said VLR is cooperatively associated with at least one network associated with a home cellular network;

an overlay or parallel service management sever, said overlay service management server configured to communicate in real time with said overlay or parallel sim card such that said server manages cellular transmission while communicating with a home network via the system VLR that is local to the cellular transmission device.

### INDEX TO RELATED APPLICATIONS

This application is a non-provisional of and claims benefit to U.S. Provisional Patent Application Serial No. 61/712,835 filed Oct. 12, 2012 the disclosure of which is incorporated herein by reference in its entirety.

### BACKGROUND OF THE INVENTION

Cellular transmissions are a part of our world in ways that previously were not contemplated. With advances in cellular transmission technology, one aspect remains unaddressed.

Cellular transmission with a device when one is not in the home geographical area of the device. Although various roaming technologies and protocols exist, they fall short of the needs addressed in the present invention.

### SUMMARY OF THE INVENTION

In one embodiment, the present invention is a system for providing access to a home cellular network when a cellular transmission device is not physically located near said home network, said system comprising:

a cellular transmission device having a home sim card configured for access to a home cellular network;

an overlay sim or other parallel standard SIM card with operator international mobile subscriber identity (IMSI) wherein said overlay sim or other parallel standard SIM card and said home sim card are constructed and arranged to function contemporaneously with a singular cellular transmission device;

a home location register (HLR), wherein said HLR is configured to be operatively associated with an operator local global title;

a visitor location register (VLR) wherein said VLR is cooperatively associated with at least one network associated with a home cellular network;

an overlay or parallel service management server, said overlay or parallel service management server configured to communicate in real time with said overlay or parallel sim card such that said server manages cellular transmission while communicating with a home network via the system VLR that is local to the cellular transmission device.

The cellular transmission device is any one of a cell phone, smart phone, tablet computer, or any device constructed and arranged with components for cellular transmission of signals.

The system home sim card and overlay sim card and are physically sized to insert simultaneously into a cellular sim card holder or the parallel sim will be inserted in the cellular sim card older.

The system utilizes an overlay or parallel server has a computer readable medium operatively associated therewith whereby said computer readable medium has stored thereon a program directing said server and system to identify each of said home sim card and overlay or parallel sim card to manage and direct communication to said overlay or parallel sim card.

Also contemplated is a method of cellular communications, said method comprising the steps of:

providing a system according to claim 1;

inserting said home sim card and said overlay or parallel sim card simultaneously into a cellular device sim card holder;

providing an overlay or parallel server;

transmitting a signal from said overlay or parallel sim card to said overlay or parallel server.

### BRIEF DESCRIPTION OF THE SEVERAL VIEWS OF THE DRAWING

FIG. 1 is a schematic showing the system registration of the present invention.

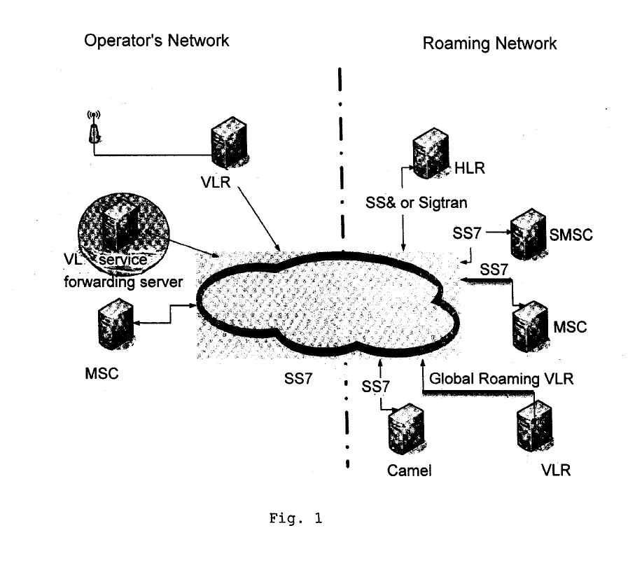

FIG. 2 is a second schematic showing the system of the present invention.

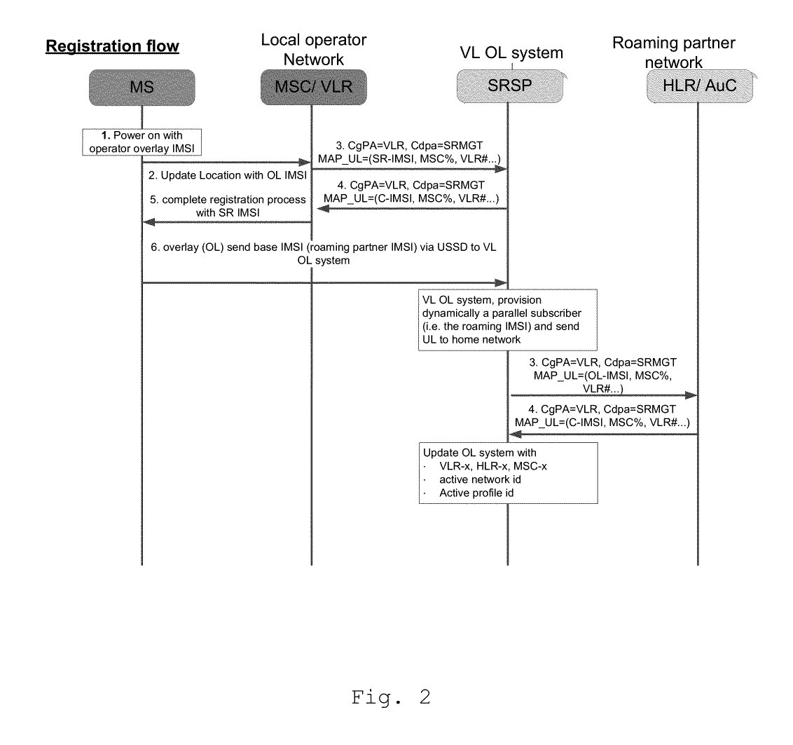

FIG. 3 is a schematic showing MT Call to home MINDS when using OL IMSI according to the present invention.

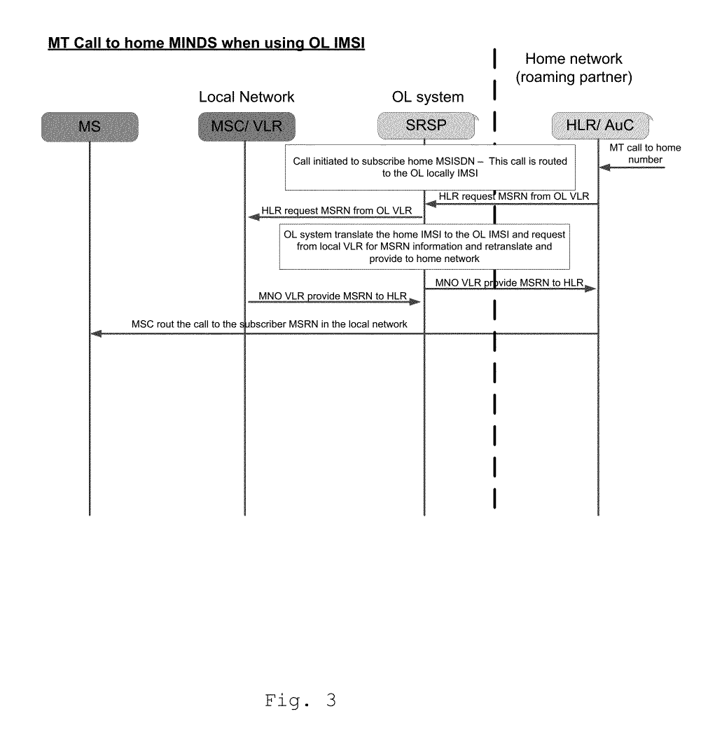

### DETAILED DESCRIPTION OF THE PREFERRED EMBODIMENT

The system and method of the present invention provides a unique configuration whereby cellular transmissions are effectively handled when the transmitting device is traveling. An international mobile subscriber identity (IMSI) is installed contemporaneously with a roaming partner sim card. It is contemplated in one embodiment of the present invention that the contemporaneous IMSI and roaming partner sim card allows for connectivity to a native or home service provider and further will allow the cellular device to place and receive calls from the home network. As used herein, home network is generally understood to mean that network which is generally associated with the cellular device. The system of the present invention in general comprises a home location register (HLR) an HLR is generally known and understood by those of skill in the art as a central data base that contains detail of mobile device subscribers that are authorized to use a particular network.

The HLR further functions as a storehouse whereby sim card details are accessed. Each sim card has a unique identifier called an IMSI which is used to access the cellular network. In addition to the HLR, the system further comprises a visitor location register (VLR) that is configured to be cooperatively associated with the networks owned and operated by various partners in the cellular industry. A third component of the present invention includes an overlay service management server. This server is uniquely designed to communicate in real time with an overlay sim card used in conjunction with a native or home sim card that directs the cellar transmission device to notify the home network through the VLR.

In one embodiment the system of the present invention provides a cellular transmission device having an overlay sim card with an operator IMSI installed in conjunction with a roaming partner sim card. When the cellular device is powered on the location of the device is updated through the IMSI. A local operator network will then communicate with a visitor location register to identify the location transmission of the cellular transmission device. A registration process will validate the cellular transmission device an operator overlay sends a base IMSI to the VLOL system. When a call is made to the cellular device the call is initiated to a subscriber home MSISDN the call is routed to the OL or parallel locally IMSI. HLR requests MSRN from OL or parallel VLR. The OL or parallel system translates the home IMSI to the OL or parallel IMSI and requests from local VLR for MSRN information and retranslate and provide access to the home network. MNO VLR provides MSRN to HLR. Finally, MSC routes the call to the transcriber MSRN in the local network.

In one embodiment:

The base SIM card is referred to as a “Queen” and the overlay or parallel is referred to as a “King.”

The King SIM is active on a device. The KING IMSI reads the Queen IMSI or in the case of parallel use the quin IMSI that stored in the parallel system and relays a transmission over USSD to the King HLR.

The King HLR uses the Queen IMSI as a parallel profile and performs update location procedure over the Queen IMSI HLR to a virtual King IMSI HLR.

When this update is complete, a call to Queen IMSI umber causes the Queen IMSI to request routing information from the King IMSI virtual VLR.

The King IMSI virtual VLR provides routing information to the Queen IMSI HLR and enables connection and completion of a transmission.

In another embodiment, referred to as a reverse call, the Queen IMSI HLR requests routing information from the King IMSI virtual VLR.

The King IMSI virtual VLR provides routing information to a virtual gateway.

The Queen IMSI HLR routes calls to a virtual gateway and the virtual gateway denies the call.

The virtual gateway, using information received from the aforementioned Queen IMSI, initiates a callback procedure tot eh King IMSI and the original initiator of the transmission.

In another embodiment, virtual call forwarding is accomplished by The King SIM is active on a device. The KING IMSI reads the Queen IMSI and relays a transmission to the King HLR.

The King HLR uses the Queen IMSI as a parallel profile and performs update location procedure over the Queen IMSI HLR to a virtual King IMSI HLR.

When this update is complete, a call to Queen IMSI umber causes the Queen IMSI to request routing information from the King IMSI virtual VLR.

The system assigns a Queen a home number to the King IMSI.

Automatic call forwarding is activated on the Queen IMSI HLR to the assigned aforementioned Queen home number.

It is understood by those having ordinary skill in the art that the system of the present invention provide transmission and management of transmissions as described herein.

Although there are many known systems and processes for handling and managing signal transmissions, the present invention has provided the unique configuration whereby the SIM card and overlay in combination provide for the advantageous signal management according to the present invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for providing access to a home cellular network when a cellular transmission device is not physically located near said home network, said system comprising:
a cellular transmission device having a home sim card configured for access to a home cellular network;
an overlay sim or the parallel card with operator international mobile subscriber identity (IMSI) wherein said overlay or parallel sim card and said home sim card are constructed and arranged to function contemporaneously with a singular cellular transmission device;
a home location register (HLR), wherein said HLR is configured to be operatively associated with an operator local global title;
a visitor location register (VLR) wherein said VLR is cooperatively associated with at least one network associated with a home cellular network;
an overlay or parallel service management sever, said overlay or parallel service management server configured to communicate in real time with said overlay or parallel sim card such that said server manages cellular transmission while communicating with a home network via the system VLR that is local to the cellular transmission device.

2. The system of claim 1 wherein said cellular transmission device is a cell phone, smart phone, tablet computer, or any device constructed and arranged with components for cellular transmission of signals.

3. The system of claim 1 wherein said home sim card and said overlay or parallel sim card and are physically sized to insert simultaneously into a cellular sim card holder.

4. The system of claim 1 wherein said overlay or parallel server has a computer readable medium operatively associated therewith whereby said computer readable medium has stored thereon a program directing said server and system to identify each of said home sim card and overlay or parallel sim card to manage and direct communication to said overlay or parallel sim card.

5. A method of cellular communications, said method comprising the steps of:
providing a system according to claim 1;
inserting said home sim card and said overlay or parallel sim card simultaneously into a cellular device sim card holder;
providing an overlay server;
transmitting a signal from said overlay sim card to said overlay server.
